(19) United States
(12) Patent Application Publication
(10) Pub. No.: US 2017/0018247 A1
(43) Pub. Date: Jan. 19, 2017

(54) IDLE FRAME COMPRESSION WITHOUT WRITEBACK

(71) Applicant: Apple Inc., Cupertino, CA (US)

(72) Inventors: Jeffrey E. Frederiksen, Sunnyvale, CA (US); Peter F. Holland, Los Gatos, CA (US)

(21) Appl. No.: 14/799,855

(22) Filed: Jul. 15, 2015

(51) Int. Cl. G09G 5/00

(52) U.S. Cl. CPC G09G 5/001; G09G 2340/02

(57) ABSTRACT

A system and method for display frame compression and write to memory are disclosed. A display pipe is configured to generate frames for display. Additionally, the display pipe may be configured to initiate compression of a frame prior to detection of an idle condition. The display pipe may also be configured to determine to selectively allow write-back logic to operate responsive to detecting various conditions. The display pipe may compress a frame and compare the size of the frame as compressed to a threshold value. If the size of the compressed frame exceeds the threshold value, write back of the compressed frame to memory is prevented. Write back of the compressed frame may be further conditioned on the detection of other conditions.

### BACKGROUND

Technical Field

Embodiments described herein relate to the field of digital systems and, more particularly, to low power mechanisms for managing displays in digital systems.

Description of the Related Art

Digital systems of various types often include, or are connected to, a display for the user to interact with the device. The display can be incorporated into the device. Examples of incorporated displays include the touchscreen on various smart phones, tablet computers, or other personal digital assistants. Another example of the incorporated display is a laptop with the screen in the lid. The display can also be connected to the device via a cable. Examples of the connected display include various desktop computers and workstations having a separate display that resides on the desk in front of the user. Some desktops also have an incorporated display (e.g., various iMac® computers from Apple Inc.). The display provides a visual interface that the user can view to interact with the system and applications executing on the system. In some cases (e.g., touchscreens), the display also provides a user interface to input to the system. Other user input devices (e.g., keyboards, mice or other pointing devices, etc.) can also be used.

In many cases, the images being displayed over a period of time are essentially static. For example, if the user is reading an ebook on the display, the display may be statically displaying a page of text until the user is finished reading the page. When a movie is paused, there may be no change in the images for the time that the pause is in effect. When a user is browsing web pages, again the user may be absorbing content and the images may be static. When there is little or no change in the static images being displayed, the memory bandwidth consumed to fetch the image each refresh cycle of the screen may be wasteful in terms of both bandwidth consumed and in power consumed.

### SUMMARY

In one embodiment, a display pipe may be configured to generate one or more frames of images and/or video sequences to generate output frames for display. Additionally, the display pipe may be configured to compress output frames and write the compressed frames to memory. The display pipe may also be configured to read compressed frames from memory for display instead of reading source frame data or other source data for generating images for display. In various embodiments, compression and write back of frames is performed responsive to detecting one or more conditions. For example, such conditions may include detecting a series of successive frames with static content (e.g., an idle screen case). As long as the condition persists, the display pipe may continue to read the compressed output frame from memory, decompress the compressed output frame, and convey the decompressed output frame to a display device. Since the image is generally unchanging when the content is static, the compressed frame may be an acceptable representation of the image to be displayed.

In various embodiments, compression of a frame may begin prior to detection of an idle condition. In some embodiments, compression may be initiated on a next to last frame before an idle frame condition is indicated. Subsequent to compressing the output frame, a determination is made regarding whether write-back logic is to write the compressed output frame back to memory. In various embodiments, the compressed frame is not written back to memory if it is determined the size of compressed frame exceeds a given threshold size. In some embodiments, the threshold size corresponds to a size of a corresponding memory buffer. Additionally, in some embodiments write back of the compressed frame is not performed if it is determined that the benefit of writing back and using the compressed frame does not meet some particular criteria. For example, if it is determined that the power that would be saved on a read of the compressed frame during the idle period does not exceed or otherwise justify the power used to compress and write back the frame, then compression may be disabled or otherwise not performed.

These and other features and advantages will become apparent to those of ordinary skill in the art in view of the following detailed descriptions of the approaches presented herein.

### BRIEF DESCRIPTION OF THE DRAWINGS

The above and further advantages of the methods and mechanisms may be better understood by referring to the following description in conjunction with the accompanying drawings, in which:

FIG. 1 is a block diagram of one embodiment of a system on a chip (SOC) coupled to a memory and a display.

FIG. 2 is a block diagram of one embodiment of a display pipeline for use in a SoC.

FIG. 3 is a block diagram of one embodiment of a display control unit.

FIG. 4 is a block diagram of one embodiment of pixel generation logic.

FIG. 5 is a generalized flow diagram illustrating one embodiment of a method for managing the idle screen on case.

FIG. 6 is a generalized flow diagram illustrating one embodiment of a method for managing the idle screen on case.

FIG. 7 is a generalized flow diagram illustrating one embodiment of a method for determining whether a benefit condition is satisfied.

FIG. 8 is a block diagram of a system including the SOC shown in FIG. 1.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

While the techniques described herein are susceptible to various modifications and alternative forms, specific embodiments thereof are shown by way of example in the drawings and will herein be described in detail. It should be understood, however, that the drawings and detailed description thereto are not intended to limit the techniques to the particular form disclosed, but on the contrary, the intention is to cover all modifications, equivalents and alternatives falling within the spirit and scope of the present embodiments as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A system comprising a display control unit . . . .” Such a claim does not foreclose the system from including additional components (e.g., a processor, a memory controller).

“Configured To.” Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112(f) for that unit/circuit/component. Additionally, “configured to” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

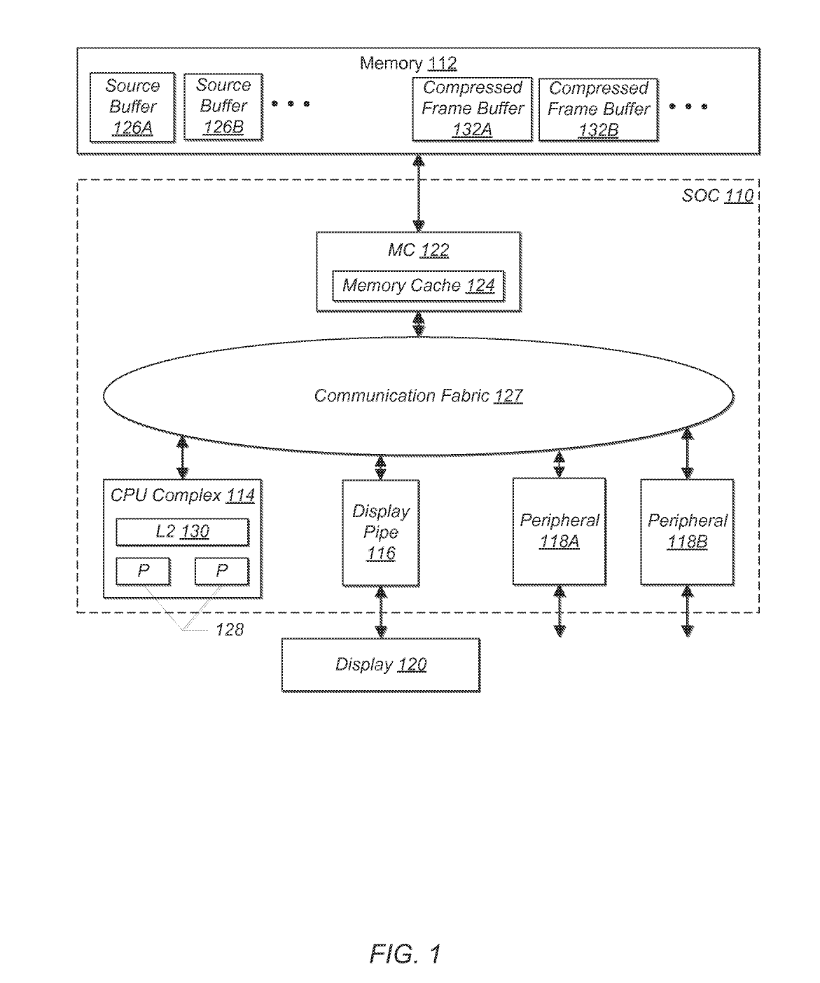

Turning now to FIG. 1, a block diagram of one embodiment of an SOC 110 is shown coupled to a memory 112 and one or more display devices 120. A display device may be more briefly referred to herein as a display. As implied by the name, the components of the SOC 110 may be integrated onto a single semiconductor substrate as an integrated circuit “chip.” In some embodiments, the components may be implemented on two or more discrete chips in a system. However, the SOC 110 will be used as an example herein. While a particular configuration and components are discussed, other embodiments are possible and are contemplated. In the illustrated embodiment, the components of the SOC 110 include a central processing unit (CPU) complex 114, a display pipe 116, peripheral components 118A-118B (more briefly, “peripherals”), a memory controller 122, and a communication fabric 127. The components 114, 116, 118A-118B, and 122 may all be coupled to a communication fabric 127. The memory controller 122 may be coupled to the memory 112 during use. Similarly, the display pipe 116 may be coupled to the display 120 during use. In the illustrated embodiment, the CPU complex 114 includes one or more processors 128 and a level two (L2) cache 130.

The display pipe 116 may include hardware to process one or more still images and/or one or more video sequences for display on the display 120. Generally speaking, for each source still image or video sequence, the display pipe 116 may be configured to generate read memory operations to read the data representing the image or frame/video sequence from the memory 112 via the memory controller 122. The display pipe 116 may be configured to perform any type of processing on the image data (still images, video sequences, etc.). In one embodiment, the display pipe 116 may be configured to scale still images and to dither, scale, and/or perform color space conversion on the frames of a video sequence. The display pipe 116 may be configured to blend the still image frames and the video sequence frames to produce output frames for display. The display pipe 116 may also be referred to herein as a display control unit. A display control unit may generally be any hardware configured to prepare a frame for display from one or more sources, such as still images and/or video sequences.

More particularly, the display pipe 116 may be configured to read from one or more source buffers 126A-126B located in the memory 112, generate frames from the source buffers, and display the resulting frames on the display 120. Accordingly, the frames displayed on the display 120 may not be directly retained during normal, dynamic operation. However, if static content is detected for a number of successive frames, the display pipe 116 may be configured to compress the resulting frame and write the compressed frame to a compressed frame buffer (e.g., 132A or 132B) in the memory 112. Alternatively, compressed frame buffer 132, or a portion thereof, may also be stored in memory cache 124 in some embodiments. In either case, the static content may be available for read and display, and the power consumed to read the multiple source buffers 126A-126B and composite the image data to generate the output frame may be avoided. In another embodiment, the resulting frame may be written back to memory 112 without compression. The frame may then be read and displayed. As used herein, reference numerals followed by an alphabetic character may generally be referred to by the reference numeral alone. For example, buffers 126A-126B may be referred to as buffers 126. It is noted that the following describes methods and apparatus operating upon an output frame for ease of discussion. However, the methods and mechanisms described herein may also be used for frames that are not, strictly speaking, an output frame. For example, in various embodiments, compression and/or decompression may be applied to only a portion of a frame. For example, an identified static portion of a frame may be decompressed while other portions of the frame may be fully processed. In such an embodiment, a static top and/or bottom portion of a frame may be compressed and/or decompressed while a non-static middle portion is fully processed. Alternatively, compression and/or decompression may be applied to frame data at an earlier stage of a pipeline. For example, some embodiments may optionally decompress a single pipe source to the blend unit, scaler unit, or unit, or directly to the display backend. Other embodiments may take into account vertical and horizontal translation using compressed data to fill the majority of the display and processing only the new edge data. These and other embodiments are possible and are contemplated.

During “normal” operation, when the idle screen is not detected, the display pipe 116 may be configured to fetch image data from source buffers 126A-126B in the memory 112 and generate output frames. In one embodiment, display pipe 116 may be configured to composite image data from multiple source buffers to generate an output frame. Compositing may include any processing by which image data from one or more images (e.g. frames from each video sequence and/or still image) are manipulated and/or combined to produce a new image. Compositing may include blending, scaling, rotating, color space conversion, etc. In general, pixels from two or more source buffers may overlap in the output frame, and display pipe 116 may be configured to operate on the pixels to produce a corresponding output pixel of the output frame.

If the source buffers 126A-126B contain full (uncompressed) frames, compression may reduce the amount of data read by a factor equal to the number of source buffers 126A-126B multiplied by the compression ratio achieved in the compressed frame compared to the full size frame. Additionally, in some embodiments in which memory cache 124 is included within memory controller 122, compressed frames may be more likely to fit in the memory cache 124 than corresponding uncompressed frames. Have the compressed frame data cached may reduce accesses to the memory 112 and thus reduce power consumption.

In one embodiment, the display pipe 116 may include circuitry configured to monitor for frames with static content (i.e., idle screen on case). More particularly, the display pipe 116 may identify multiple successive frames with static content. In another embodiment, software executing on processors 128 may identify multiple successive frames with static content and provide a corresponding indication to display pipe 116. Generally, static content may refer to content that is not changing from frame to frame (e.g., each pixel is the same from frame to frame). In some cases, static content may refer to content that is changing by less than a threshold amount over a sequence of different frames, such that displaying a single frame repeatedly is deemed an acceptable approximation to display of the multiple different frames. In various embodiments, the idle screen case may represent a scenario in which the user is viewing displayed data which is unchanging, such as an ebook, a web page, an email, or otherwise. Alternatively, the user may have paused a video or a sequence of frames in a video is relatively unchanged. Numerous such scenarios are possible and are contemplated.

The display 120 may be any sort of visual display devices. The display may include, for example, touch screen style displays for mobile devices such as smart phones, tablets, etc. Display 120 may include liquid crystal display (LCD), light emitting diode (LED), plasma, cathode ray tube (CRT), etc. The display 120 may be integrated into a system including the SOC 110 (e.g. a smart phone or tablet) and/or may be a separately housed device such as a computer monitor, television, or other device. The display 120 may also include one or more displays coupled to the SOC 110 over a network (wired or wireless).

In some embodiments, the display 120 may be directly connected to the SOC 110 and may be controlled by the display pipe 116. That is, the display pipe 116 may include hardware (a “backend”) that may provide various control/data signals to the display, including timing signals such as one or more clocks and/or the vertical blanking interval and horizontal blanking interval controls. The clocks may include the pixel clock indicating that a pixel is being transmitted. The data signals may include color signals such as red, green, and blue, for example. The display pipe 116 may control the display 120 in real-time, providing the data indicating the pixels to be displayed as the display is displaying the image indicated by the frame. The interface to such a display 120 may be, for example, VGA, HDMI, digital video interface (DVI), a liquid crystal display (LCD) interface, a plasma interface, a cathode ray tube (CRT) interface, any proprietary display interface, etc.

The CPU complex 114 may include one or more CPU processors 128 that serve as the CPU of the SOC 110. The CPU of the system includes the processor(s) that execute the main control software of the system, such as an operating system. Generally, software executed by the CPU during use may control the other components of the system to realize the desired functionality of the system. The CPU processors 128 may also execute other software, such as application programs. The application programs may provide user functionality, and may rely on the operating system for lower level device control. Accordingly, the CPU processors 128 may also be referred to as application processors. The CPU complex may further include other hardware such as the L2 cache 130 and/or and interface to the other components of the system (e.g., an interface to the communication fabric 127).

The peripherals 118A-118B may be any set of additional hardware functionality included in the SOC 110. For example, the peripherals 118A-118B may include video peripherals such as video encoder/decoders, image signal processors for image sensor data such as camera, scalers, rotators, blenders, graphics processing units, etc. The peripherals may include audio peripherals such as microphones, speakers, interfaces to microphones and speakers, audio processors, digital signal processors, mixers, etc. The peripherals may include interface controllers for various interfaces external to the SOC 110 including interfaces such as Universal Serial Bus (USB), peripheral component interconnect (PCI) including PCI Express (PCIe), serial and parallel ports, etc. The peripherals may include networking peripherals such as media access controllers (MACs). Any set of hardware may be included.

The memory controller 122 may generally include circuitry for receiving memory operations from the other components of the SOC 110 and for accessing the memory 112 to complete the memory operations. The memory controller 122 may be configured to access any type of memory 112. For example, the memory 112 may be static random access memory (SRAM), dynamic RAM (DRAM) such as synchronous DRAM (SDRAM) including double data rate (DDR, DDR2, DDR3, etc.) DRAM. Low power/mobile versions of the DDR DRAM may be supported (e.g. LPDDR, mDDR, etc.). The memory controller 122 may include various queues for buffering memory operations, data for the operations, etc., and the circuitry to sequence the operations and access the memory 112 according to the interface defined for the memory 112.

In the illustrated embodiment, the memory controller 122 may include a memory cache 124. The memory cache 124 may store data that has been read from and/or written to the memory 112. The memory controller 122 may check the memory cache 124 prior to initiating access to the memory 112. Power consumption on the memory interface to the memory 112 may be reduced to the extent that memory cache hits are detected (or to the extent that memory cache allocates are performed for write operations). Additionally, latency for accesses that are memory cache hits may be reduced as compared to accesses to the memory 112, in some embodiments.

The communication fabric 127 may be any communication interconnect and protocol for communicating among the components of the SOC 110. The communication fabric 127 may be bus-based, including shared bus configurations, cross bar configurations, hierarchical buses with bridges, or otherwise. The communication fabric 127 may also be packet-based, and may be hierarchical with bridges, cross bar, point-to-point, or other interconnects.

It is noted that the number of components of the SOC 110 (and the number of subcomponents for those shown in FIG. 1, such as within the CPU complex 114) may vary from embodiment to embodiment. There may be more or fewer of each component/subcomponent than the number shown in FIG. 1.

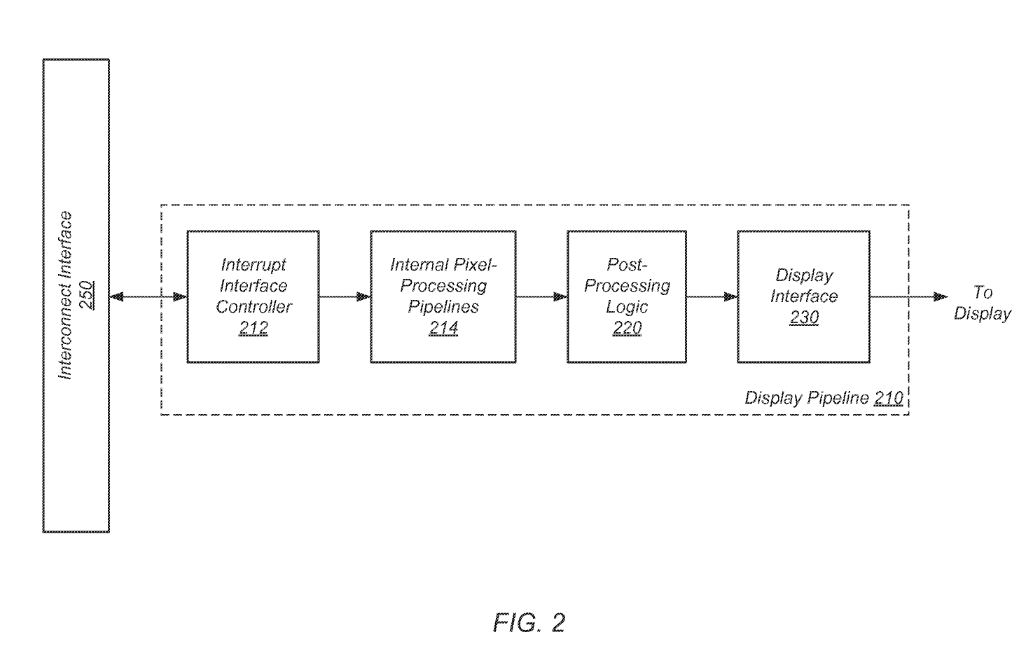

Turning now to FIG. 2, a generalized block diagram of one embodiment of a display pipeline for use in a SoC is shown. Although one display pipeline is shown, in other embodiments, the host SOC (e.g., SOC 110) may include multiple display pipelines. Generally speaking, display pipeline 210 may be configured to process a source image and send rendered graphical information to a display (not shown).

Display pipeline 210 may be coupled to interconnect interface 250 which may include multiplexers and control logic for routing signals and packets between the display pipeline 210 and a top-level fabric. The interconnect interface 250 may correspond to communication fabric 127 of FIG. 1. Display pipeline 210 may include interrupt interface controller 212. Interrupt interface controller 212 may include logic to expand a number of sources or external devices to generate interrupts to be presented to the internal pixel-processing pipelines 214. The controller 212 may provide encoding schemes, registers for storing interrupt vector addresses, and control logic for checking, enabling, and acknowledging interrupts. The number of interrupts and a selected protocol may be configurable.

Display pipeline 210 may include one or more internal pixel-processing pipelines 214. The internal pixel-processing pipelines 214 may include one or more pipelines (e.g., Alpha, Red, Green, Blue pipelines) for processing and displaying user interface (UI) layers. The internal pixel-processing pipelines 214 may also include one or more pipelines for processing and displaying video content such as YUV content. YUV content is a type of video signal that consists of one signal for luminance or brightness and two other signals for chrominance or colors. In various embodiments, YUV content may replace a traditional composite video signal. For example, the MPEG-2 encoding system in the DVD format uses YUV content. The internal pixel-processing pipelines 214 may handle the rendering of the YUV content. In some embodiments, internal pixel-processing pipelines 214 may include blending circuitry for blending graphical information before sending the information as output to post-processing logic 220.

In various embodiments, a presentation layer may consist of multiple software components used to define one or more images to present to a user. The UI layer may include components for at least managing visual layouts and styles and organizing browses, searches, and displayed data. The presentation layer may interact with process components for orchestrating user interactions and also with a business or application layer and the data access layer to form an overall solution.

Internal pixel-processing pipelines 214 may also include compression and write-back logic for compressing an output frame and then writing the compressed output frame back to memory when an idle frame condition (or “idle condition”) is detected. Internal pixel-processing pipelines 214 may also include decompression logic for decompressing the compressed output frame and then conveying the result to post-processing logic 220 for as long as the idle frame condition persists.

The post-processing logic 220 may be used for color management, ambient-adaptive pixel (AAP) modification, dynamic backlight control (DPB), panel gamma correction, and dither. The display interface 230 may handle the protocol for communicating with the display. For example, in one embodiment, a DisplayPort interface may be used. Alternatively, the Mobile Industry Processor Interface (MIPI) Display Serial Interface (DSI) specification or a 4-lane Embedded Display Port (eDP) specification may be used. It is noted that the post-processing logic and display interface may be referred to as the display backend.

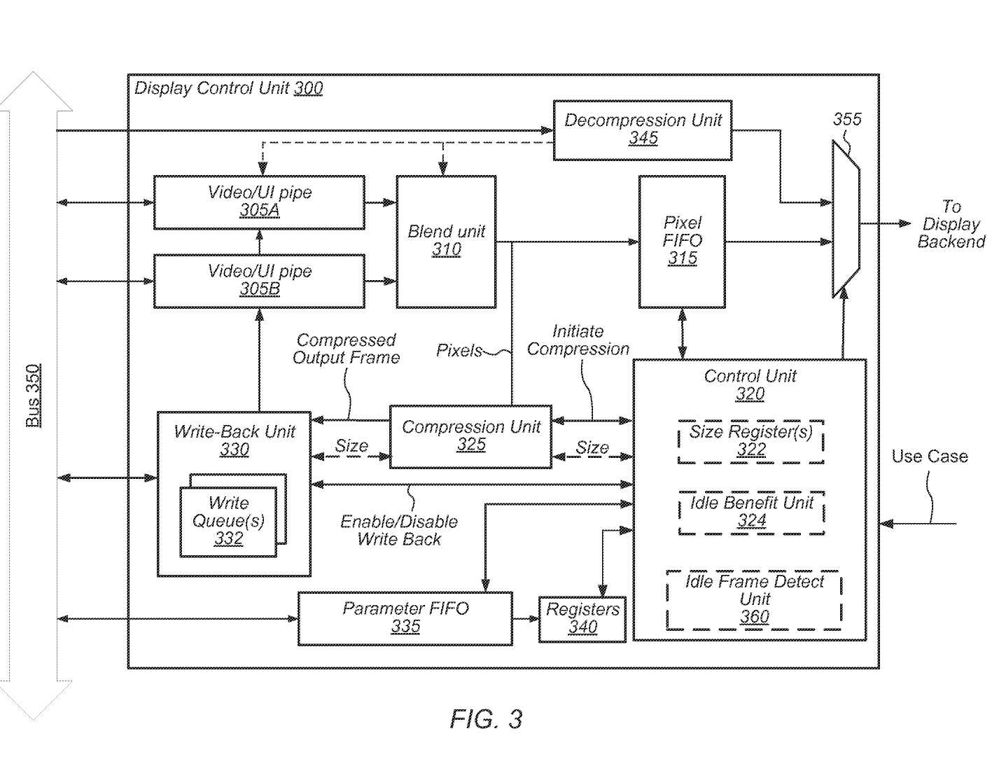

Referring now to FIG. 3, one embodiment of a display control unit 300 is shown. Display control unit 300 may represent display pipe 116 included in SoC 110 of FIG. 1. Display control unit 300 may be coupled to a system bus 350 and to a display backend (not shown). In some embodiments, a display backend may directly interface to the display to display pixels generated by display control unit 300. Display control unit 300 may include functional sub-blocks such as one or more video/user interface (UI) pipelines 305A-B, blend unit 310, pixel First-In, First-Out buffer (FIFO) 315, control unit 320, compression unit 325, write-back unit 330, parameter FIFO 335, registers 340, decompression unit 345, and mux 355. Display control unit 300 may also include other components which are not shown in FIG. 3 to avoid cluttering the figure.

System bus 350, in some embodiments, may correspond to communication fabric 127 from FIG. 1. System bus 350 couples various functional blocks such that the functional blocks may pass data between one another. Display control unit 300 may be coupled to system bus 350 in order to receive video frame data for processing. The display control unit 300 may include one or more video/UI pipelines 305A-B, each of which may be a video and/or user interface (UI) pipeline depending on the embodiment. It is noted that the terms “video/UI pipeline”, “pixel processing pipeline”, and “pixel generation logic” may be used interchangeably herein. In other embodiments, display control unit 300 may have one or more dedicated video pipelines and/or one or more dedicated UI pipelines. Each video/UI pipeline 305 may fetch a video or image frame from a buffer coupled to system bus 350. The buffered video or image frame may reside in a system memory such as, for example, system memory 112 from FIG. 1. Each video/UI pipeline 305 may fetch a distinct image and may process the image in various ways, including, but not limited to, format conversion (e.g., YCbCr to ARGB), image scaling, and dithering. In some embodiments, each video/UI pipeline 305 may process one pixel at a time, in a specific order from the video frame, outputting a stream of pixel data, and maintaining the same order as pixel data passes through.

Blend unit 310 may receive a pixel stream from one or more video/UI pipelines 305. If only one pixel stream is received, blend unit 310 may simply pass the stream through to the next sub-block. However, if more than one pixel stream is received, blend unit 310 may blend the pixel colors together to create an image to be displayed. In various embodiments, blend unit 310 may be used to transition from one image to another or to display a notification window on top of an active application window. For example, a top layer video frame for a notification, such as, for a calendar reminder, may need to appear on top of an internet browser window. The calendar reminder may comprise some transparent or semi-transparent elements in which the browser window may be at least partially visible, which may require blend unit 310 to adjust the appearance of the browser window based on the color and transparency of the calendar reminder.

In some embodiments, the blended pixel stream may be converted to a different color space after gamut corrections have been applied. For example, the color space may be changed based on the intended target display. The output of blend unit 310 may be a single pixel stream composite of the one or more input pixel streams. The pixel stream output of blend unit 310 may be sent to pixel FIFO 315 and to compression unit 325. In other embodiments, the pixel stream may be sent to other target destinations. For example, the pixel stream may be sent to a network interface. It is noted that while a pixel FIFO 315 is described herein, other structures configured to store data are possible and are contemplated.

Blend unit 310 may be configured to convey pixels to both compression unit 325 and pixel FIFO 315 for the first frame after an idle frame condition has been detected. For subsequent frames while the idle frame condition still applies, assuming the write-back of the compressed output frame was successfully completed, one or more units such as the blend unit 310 may be turned off, power-gated, clock-gated, or otherwise placed into a dormant state, and decompression unit 345 may drive the decompressed output frame to the display backend via mux 355.

Pixel FIFO 315 may be configured to store pixels output from blend unit 310. A FIFO as used and described herein, may refer to a memory storage buffer in which data stored in the buffer is read in the same order it was written. A FIFO may be comprised of RAM or registers and may utilize pointers to the first and last entries in the FIFO. During “normal” operation, pixel FIFO 315 may be the interface to the display backend (not shown), which may control the display to display the pixels generated by display control unit 300. In one embodiment, the display backend may read pixels at a regular rate from output FIFO 310 according to a pixel clock. The rate may depend on the resolution of the display as well as the refresh rate of the display. For example, a display having a resolution of N×M and a refresh rate of R frames per second may have a pixel clock frequency based on N×M×R. On the other hand, pixel FIFO 315 may be written by blend unit 310 as pixels are generated by blend unit 310. In some instances, the rate at which display control unit 300 generates pixels may be faster than the rate at which the pixels are read, assuming that data is provided to display control unit 300 from the memory (not shown) quickly enough. The pixels in pixel FIFO 315 may thus be a measure of a margin of safety for display control unit 300 before erroneous operation is observed on the display.

Control unit 320 may receive various control signals and include various control logic for managing the overall operation of display control unit 300. For example, control unit 320 may receive a signal to indicate a new video frame is ready for processing. In some embodiments, this signal may be generated outside of display control unit 300 and in other embodiments display control unit 300 may generate the signal. In some embodiments, display control unit 300 may include a parameter FIFO 335. The parameter FIFO 335 may store values to be written to the configuration registers 340 for subsequent frames. The same configuration of registers may be used for multiple frame generations, in some embodiments, and thus the parameter FIFO 335 may include data that indicates how many frames should be processed with a given configuration before a new configuration is used. The parameter FIFO 335 may further store register addresses of the configuration registers 340 and data to be written to those registers 340. The parameter FIFO 335 may thus be a mechanism to store a stream of frame processing in display control unit 300 and then permit display control unit 300 to perform the stream. Various other parameters that display control unit 300 uses to control how the various sub-blocks manipulate the video frame may also be stored in registers 340. Registers 340 may include data setting input and output frame sizes, setting input and output pixel formats, location of the source frames, and destination of the output. In some embodiments, size registers 322 may be used to indicate a maximum size of memory allocated for use in storing uncompressed and or compressed frames in memory. In the embodiment shown, such registers 322 are shown in control unit 320. However, size registers 322 may be included as part of registers 340, and/or may be located elsewhere with the SOC. In various embodiments, the values stored in size registers 322 are programmable. For example, in some embodiments, values stored in the registers 322 are stored during a boot or initialization sequence. In other embodiments, such values may be stored or updated at other times.

In some embodiments, control unit 320 may designate a quality of service (QoS) state for each pixel fetch request and/or writeback request. The QoS states may be utilized to control the priority of requests that are sent to memory from display control unit 300. In one embodiment, there may be three QoS levels—green, yellow, and red corresponding to low, medium, and high levels of priority, respectively. The QoS information may be generated per request and/or may be communicated to the communication fabric and memory subsystem via sideband signaling. Generally speaking, control unit 320 may be configured to select the output of pixel FIFO 315 through the mux 355 when the output frame content is changing. When an idle frame condition has been detected and after the compressed output frame has been successfully written back to memory, control unit 320 may select the output of decompression unit 345 through mux 355 to drive the display backend. Control unit 320 may also be configured to disable video/UI pipelines 305A-B, blend unit 310, and pixel FIFO 315 responsive to the compressed frame being successfully written back to memory.

In various embodiments, the idle screen detect unit 360 may be configured to detect an idle frame condition. For example, unit 360 may be configured to detect whether or not the content of a frame has changed from the previous frame. There may be a variety of mechanisms for detecting whether or not the content is changing. In some embodiments, software or another unit of the host SoC (e.g., SoC 110) may be configured to detect the idle frame condition and then send an indication to display control unit 300.

In some embodiments, when the content of a frame has not changed for a given number of frames or a given period of time, an idle screen condition is detected. The given number of frames or period of time may be programmable in various embodiments. As an example, in one embodiment, an idle frame condition is detected when three consecutive frames are detected with the same (or less than some threshold change in the amount of) content. In some embodiments, control unit 320 is configured to convey an initiate compression signal to compression unit 325 that causes the compression unit 325 to begin compression of a frame. In various embodiments, control unit 320 may convey the initiate compression signal on detection of a predetermined, or programmable, number of unchanging detected frames. In various embodiments, compression unit 325 may be configured to begin compressing a frame prior to detection of an idle frame condition. For example, in an embodiment in which an idle frame condition is detected after three consecutive unchanging frames, the initiate compression signal may be conveyed after detecting two consecutive unchanging frames. Other embodiments may use different numbers of frames for detecting an idle condition and/or initiating compression. As mentioned above, some embodiments may detect an idle frame condition when a given number of frames are detected that, while not identical, have less than a threshold amount of change. In such embodiment, the threshold amount of change may be based on algorithms that compare an amount of change between two or more frames, analyze an amount of changed data solely within a single frame (e.g., an MPEG P-frame, B-frame, P-slices, or B-slices, etc.), or use other algorithms designed to determine whether detected changes are visually perceptible to the human eye. Whether changes are visually perceptible may include not only the content of the change itself, but may also take into account the size of the display that is being used. For example, a change that is visually perceptible on a 50″ television screen may not be perceptible (or may not be deemed visually significant even if perceptible) on a mobile phone. In such embodiments, more aggressive approaches to compression and write back may be used. These and other embodiments are possible and are contemplated.

When the initiate compression signal detected (or some other indication that the compression unit 325 is to begin compression), compression unit 325 may be configured to compress pixels as they are generated (e.g., by blend unit 310 in one embodiment). In some embodiments, compression unit 325 may convey compressed data to write-back unit 330 as pixels are simultaneously conveyed from blend unit to pixel FIFO 315. It is noted that write-back unit 330 may also be referred to as the “write-back logic”. Any suitable type of compression (e.g., lossless, lossy) may be utilized depending on the embodiment. In response, compression unit 325 begins compression of the detected frame (e.g., the second frame in the above described embodiment) which may be conveyed to write back unit 330. In various embodiments, a write queue(s) 332 or some other buffer may be used to store the compressed frame.

Upon completion of compression of this frame, a determination is made as to whether or not the write back unit 330 is to write the compressed frame to memory (or another storage location) via bus 350. In various embodiments, a write back of the compressed frame is or is not performed depending on certain conditions. For example, in some embodiments the write back unit 330 may not write back the compressed frame unless an idle condition has been detected. In one embodiment, idle frame detect unit 360 may be configured to convey a signal that indicates whether or not an idle frame condition is detected. In the above described embodiment, the compressed frame received by the write back unit 330 corresponds to the second consecutive unchanging frame detected. However, the idle frame condition is not detected until three consecutive unchanging frames are detected. If such a third frame is detected, then the enable/disable write back signal may indicate a write back is to be performed and the third frame is compressed and written back to memory.

In embodiments in which compressed frame data is conveyed to the write back unit as it is compressed, when the compression begins (e.g., on the second frame prior to detection of an idle condition) the compressed data may simply be discarded. This may be appropriate, for example, in embodiments there is not sufficient storage to buffer an entire compressed frame. In other embodiments, as the frame data is compressed by compression unit 325, the compressed data may be discarded without conveying it to the write back unit. Rather, the compression unit 325 simply compresses the frame data and determines various characteristics (e.g., size) associated with the compressed data. If the idle frame condition is detected (e.g., on the third frame), then the third frame is compressed and written back to memory. These and other embodiments are possible and are contemplated.

In some embodiments, detection of an idle frame condition is only one of multiple conditions that must be present for a write back of the compressed frame to occur. For example, in various embodiments, size registers 322 indicate a threshold size of a buffer in memory that may be used to store a compressed frame. If a frame compressed by the compression unit 325 exceeds the indicated threshold, then a write back of the compressed frame is not performed. In some embodiments, the compression unit 325 may convey an indication of the compressed frame size to the control unit 320 (e.g., via the “Size” signal, or otherwise). The control unit 320 may then use this indication to determine whether or not write back is to be enabled or disabled.

As an example, if the size does not exceed the threshold and an idle frame condition has been detected, then a write back of the compressed frame may be performed. If either the size exceeds the threshold or an idle frame condition is not detected, then a write back of the compressed frame is not performed. In some embodiments, compression unit 325 may convey an indication of the size of the compressed frame to the write back unit 330. Write back unit 330 may have access to, or otherwise have received, an indication of the values stored in size registers 322. In such an embodiment, idle frame detect unit 360 may convey an indication that an idle frame condition has been detected and write back unit 330 may make a determination as to whether the compressed frame size exceeds the threshold. If the size is exceeded, then write back unit 330 may determine that a write back of the compressed frame is not to be performed. Additionally, in some embodiments, control unit 320 may determine whether to allow write-back based on additional factors such as the status of the memory system, the number and QoS status of outstanding memory transactions, status of other functional blocks in the host SoC, number of received but unprocessed pixels in video/UI pipes 305A-B, and/or one or more other metrics. These and other alternative embodiments are possible and are contemplated.

In various embodiments, multiple buffers may be associated with frame data. For example, in some embodiments, frame data may correspond to an RGB color space. In such an embodiment, each pixel may have an R, G, and B component. Other embodiments may correspond to a YUV color space, or have pixel data in a Y Cb Cr format. In such embodiments, size registers 322 may indicate a threshold size for buffers corresponding to each of these components. When the compression unit 325 compresses data corresponding to each of these components, the size of the compressed data may be compared to a respective threshold size. If various embodiment, if any one of the compressed sizes exceeds the threshold, then a write back of the frame data is not performed. Further, in some embodiments, there may also be a total size threshold indicated for the combined (e.g., RGB) compressed component data. If the cumulative size of the compressed components exceeds the total size threshold, then write back of the frame data is not performed. When using a total size threshold for multiple pixel components, some embodiments may permit a given component to exceed a threshold size if the total size is not exceeded. In some embodiments, the total size threshold is less than the sum of the size thresholds for the individual components. Various combinations of how to use individual component thresholds and total size thresholds in determining whether write back is permitted are possible and are contemplated.

In addition to the above, various embodiment may be configured to determine whether compression and/or write back is to be performed based on other conditions. For example, some embodiments may perform compression and/or write back if it is determined an idle frame condition will persist for at least at threshold amount of time. For example, various embodiments may estimate an idle frame condition will persist for at least a given period of time based on one or more factors. In some embodiments, the factors may be experimentally determined based on common use case scenarios. Based on such experiments, particular values may be programmed into the device 110 that are then used by control unit 320. As one example, control unit 320 is shown to include an idle benefit unit 324 that may be generally configured to indicate whether or not compression and/or write back is to be performed. For example, unit 324 may be as simple as one or more registers that store values indicating a threshold number of frames to be used to identify when compression and/or write back is performed. In some embodiments, these values may be different from those discussed above (i.e., three consecutive unchanged frames used to detect an idle frame condition) and may be used as a separate condition for determining whether compression and/or write back is performed. Alternatively, these values may be used to establish the threshold discussed above (e.g., the number of unchanged frames was chosen to be three based on experimentally gathered statistics).

In other embodiments, idle benefit unit 324 (which may be located in other than the control unit 320), may include circuitry configured to determine and/or detect certain use case scenarios. In such embodiments, the number of unchanged frames to be used for allowing compression and/or write back may vary. In some embodiments, the use case may be indicated by a received signal (e.g., as indicated by “Use Case” signal), a register value, or otherwise. For example, the use case may corresponds to a particular application that is executing. Additionally, in some embodiments, the use case may correspond to a particular user. In these or other cases, a history of use corresponding to a particular application or user may be maintained to determine values for use in a particular use case scenario. Such a history may include maintaining an average number of idle frames for a use case, average period of time for idle frame conditions in a use case, maximum and minimum values for use cases, and so on. Such details may be maintained locally or remotely (e.g., in the cloud). In various embodiments, such details may be associated with a user or user account such that they can be used for a new device when the user changes to a different device (e.g., upgrades to a new smartphone).

In various embodiments, the threshold values that are set take into consideration overhead power consumed to compress, write back, and/or read back compressed frame data. Such values could also vary based on various performance states of one or more components in the system. For example, if a memory subsystem is capable of operating at multiple performance states with varying levels of power consumption, the values used for determining the above discussed thresholds could vary dynamically based on these states. Other conditions that might affect the thresholds include observed behaviors of a given user. For example, if the history of a given user shows that the user typically recharges the device (e.g., a smartphone device) at approximately 8 pm each day, and the current time is 7 pm, it may be determined that higher power consumption is acceptable based on the current usage of the device as it is predicted the current battery supply will be sufficient. These and other embodiments are possible and are contemplated.

It is noted that the display control unit 300 illustrated in FIG. 3 is merely an example. In other embodiments, different functional blocks and different configurations of functional blocks may be possible depending on the specific application for which the display control unit is intended. For example, more than two video/UI pipelines may be included within a display control unit in other embodiments. Additionally, two or more units shown separately within display control unit 300 may be combined within a single functional sub-block in another embodiment.

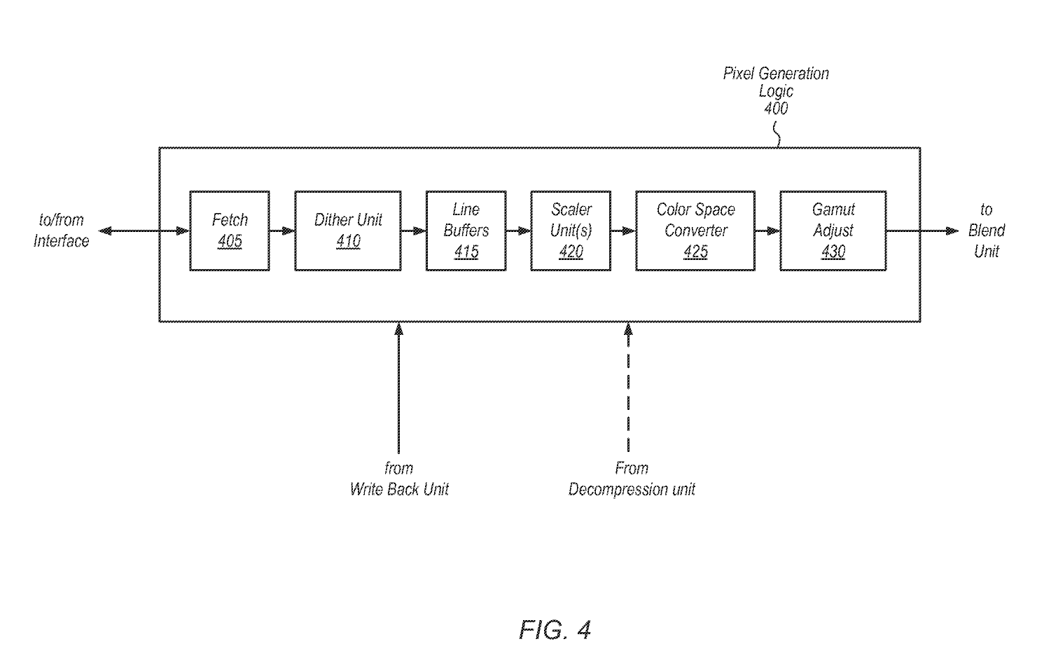

Turning now to FIG. 4, a block diagram of one embodiment of pixel generation logic 400 is shown. Pixel generation logic 400 may correspond to video/UI pipelines 301A and 301B of display pipeline 300 as illustrated in FIG. 3. In the illustrated embodiment, pixel generation logic 400 includes fetch unit 405, dither unit 410, line buffers 415, scaler unit(s) 420, color space converter 425, and gamut adjust unit 430. Gamut adjust unit 430 may be coupled to blend unit and the write-back unit. When not in the idle screen on case, pixel generation logic 400 may be responsible for fetching pixel data for source frames stored in a memory, and then processing the fetched data before sending the processed data to a blend unit, such as, blend unit 302 of display control unit 300 as illustrated in FIG. 3.

Fetch unit 405 may be configured to generate read requests for source pixel data being processed by pixel generation logic 400. Each read request may include one or more addresses indicating where the portion of data is stored in memory. In some embodiments, address information included in the read requests may be directed towards a virtual (also referred to herein as “logical”) address space, wherein addresses do not directly point to physical locations within a memory device. In such cases, the virtual addresses may be mapped to physical addresses before the read requests are sent to the source buffer. A memory management unit may, in some embodiments, be used to map the virtual addresses to physical addresses. In some embodiments, the memory management unit may be included within the display pipeline, while in other embodiments, the memory management unit may be located elsewhere within a computing system.

Under certain circumstances, the total number of colors that a given system is able to generate or manage within the given color space—in which graphics processing takes place—may be limited. In such cases, a technique called dithering is used to create the illusion of color depth in the images that have a limited color palette. In a dithered image, colors that are not available are approximated by a diffusion of colored pixels from within the available colors. Dithering in image and video processing is also used to prevent large-scale patterns, including stepwise rendering of smooth gradations in brightness or hue in the image/video frames, by intentionally applying a form of noise to randomize quantization error. Dither unit 410 may, in various embodiments, provide structured noise dithering on the Luma channel of YCbCr formatted data. Other channels, such as the chroma channels of YCbCr, and other formats, such as ARGB may not be dithered.

Line buffers 415 may be configured to store the incoming frame data corresponding to row lines of a respective display screen. The frame data may be indicative of luminance and chrominance of individual pixels included within the row lines. Line buffers 415 may be designed in accordance with one of various design styles. For example, line buffers 415 may be SRAM, DRAM, or any other suitable memory type. In some embodiments, line buffers 415 may include a single input/output port, while, in other embodiments, line buffers 415 may have multiple data input/output ports.

In some embodiments, scaling of source pixels may be performed in two steps. The first step may perform a vertical scaling, and the second step may perform a horizontal scaling. In the illustrated embodiment, scaler unit(s) 420 may perform the vertical and horizontal scaling. Scaler unit(s) 420 may be designed according to any of varying design styles. In some embodiments, the vertical scaler and horizontal scaler of scaler unit(s) 420 may be implemented as 9-tap 32-phase filters. These multi-phase filters may, in various embodiments, multiply each pixel retrieved by fetch unit 405 by a weighting factor. The resultant pixel values may then be added, and then rounded to form a scaled pixel. The selection of pixels to be used in the scaling process may be a function of a portion of a scale position value. In some embodiments, the weighting factors may be stored in a programmable table, and the selection of the weighting factors to use in the scaling may be a function of a different portion of the scale position value.

Color management within pixel generation logic 400 may be performed by color space converter 425 and gamut adjust unit 430. In some embodiments, color space converter 425 may be configured to convert YCbCr source data to the RGB format. Alternatively, color space converter may be configured to remove offsets from source data in the RGB format. Color space converter 425 may, in various embodiments, include a variety of functional blocks, such as an input offset unit, a matrix multiplier, and an output offset unit (all not shown). The use of such blocks may allow the conversion from YCbCr format to RGB format and vice-versa. In the example shown, the write-back unit may be configured to convey an indication to logic 400 that indicates the fetch unit 405 and/or other units may be turned off or otherwise placed in a reduced power state. Also, as discussed above, in some embodiments, output from the decompression unit may be coupled to provide data to one or more of the units in logic 400.

In various embodiments, gamut adjust unit 430 may be configured to convert pixels from a non-linear color space to a linear color space, and vice-versa. In some embodiments, gamut adjust unit 430 may include a Look Up Table (LUT) and an interpolation unit. The LUT may, in some embodiments, be programmable and be designed according to one of various design styles. For example, the LUT may include a SRAM or DRAM, or any other suitable memory circuit. In some embodiments, multiple LUTs may be employed. For example, separate LUTs may be used for Gamma and De-Gamma calculations. The output of gamut adjust unit 430 may be coupled to blend unit 435. Although not shown, one or more other pixel generation pipelines may also be coupled to blend unit 435. The output of blend unit 435 may be coupled to write-back logic 440 and the pixel buffer (not shown). It is noted that the embodiment illustrated in FIG. 4 is merely an example. In other embodiments, different functional blocks and different configurations of functional blocks may be utilized.

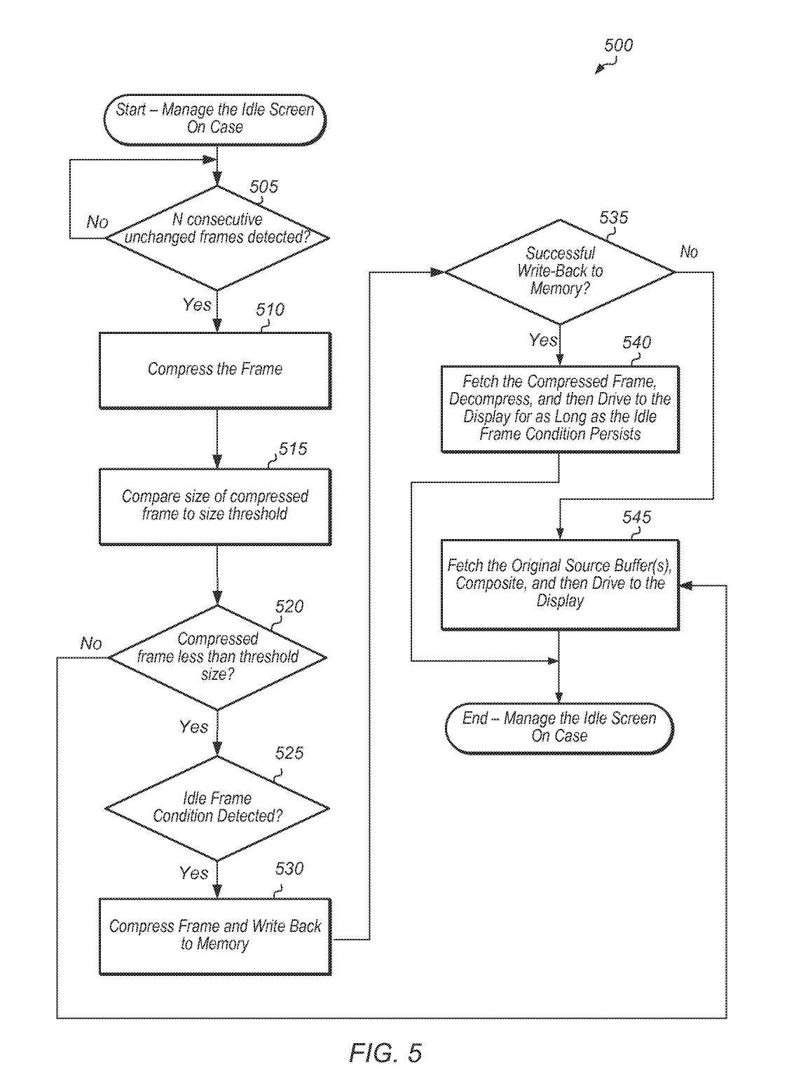

Turning now to FIG. 5, one embodiment of a method 500 for managing the idle screen on case is shown. The components embodied in SoC 110 (of FIG. 1) described above (e.g., display pipe 116) or display control unit 300 of FIG. 3 may generally operate in accordance with method 500. In addition, the steps in this embodiment are shown in sequential order. However, some steps may occur in a different order than shown, some steps may be performed concurrently, some steps may be combined with other steps, and some steps may be absent in another embodiment.

The display pipeline may detect or receive an indication that N consecutive unchanged frames have occurred, where N is an integer (block 505). In one embodiment, the display pipeline may detect N consecutive unchanged frames. In another embodiment, software executing on the host SoC or another unit may detect this condition and notify the display pipeline. In response to the N consecutive unchanged frames, the display pipeline may be configured to compress the output frame while simultaneously driving the output frame to the display (block 510). Subsequent to compressing the frame, the size of the frame as compressed is compared to a threshold value (block 515). As described, such a threshold value may be stored in a register. If the compressed frame size is less than (or less than or equal to in various embodiments) the threshold size and an idle frame condition has been detected (block 525), then a write back of the compressed frame to memory may be initiated (block 530). On the other hand, if the compressed frame size exceeds the threshold size value, then the process may bypass write back of the compressed frame, proceed to block 545 and fetch original source buffer data. It is noted that in some embodiments, compression of the frame may not need to be completed before determining the size threshold has been exceeded. For example, if compression begins (block 510) and the size threshold is exceeded before compression is complete, then compression could cease and the process proceed directly to block 545.

If the compressed frame size does not exceed the threshold, the write back is initiated (block 530) and a determination may be made as to whether the write back is successful (block 535). If the write back is successful, then the compressed output frame may be fetched from memory, decompressed, and driven to the display for as long as the idle frame condition persists (block 540). As discussed above, various units may be placed in a reduced power state while the idle frame condition continues. If for some reason the write back is not successful, the process may continue with block 545 by fetching the original uncompressed frame buffer data.

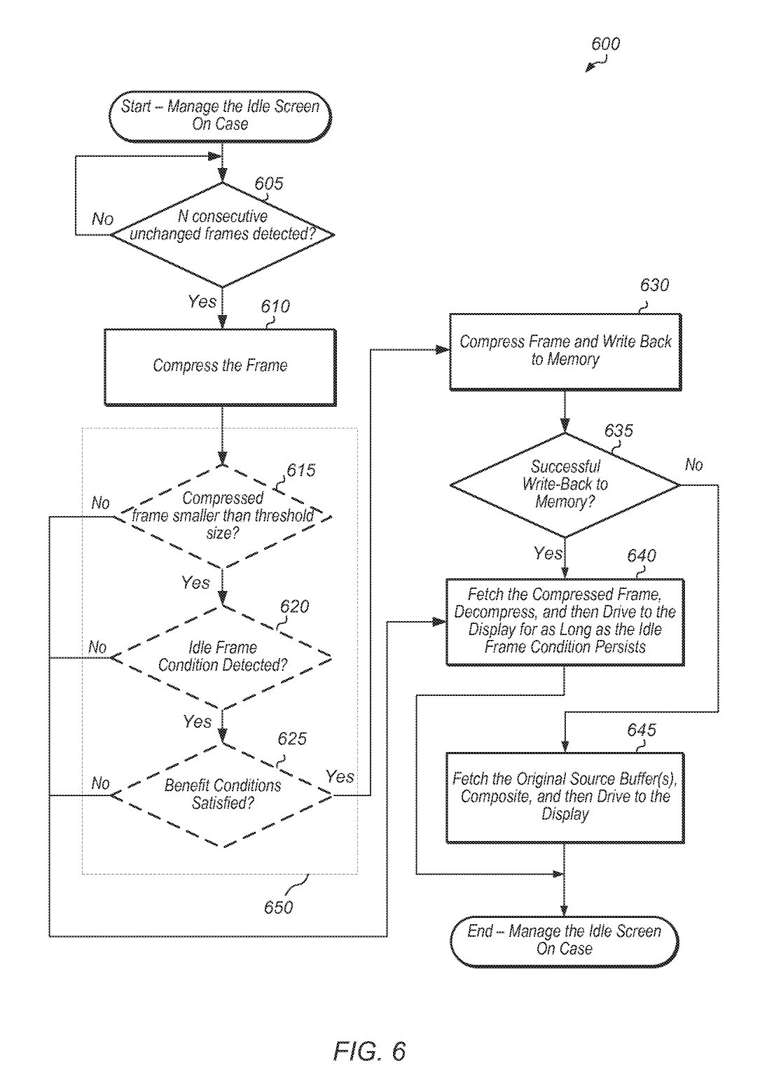

As discussed above, there are a variety of conditions and factors that may be utilized in determining whether compression and write back of compressed data should be performed. FIG. 6 illustrates an embodiment 600 in which a variety of conditions may be used when determining whether compressions and write back of frame data is to be performed. In the example of FIG. 6, block 650 illustrates a number of conditions that may be checked when determining whether to write back a compressed frame. In various embodiments, any combination of these blocks (615, 620, 625) may be used.

In this example, if N consecutive unchanged frames are detected (block 605), then the output frame may be compressed as discussed above (block 610). Subsequently, one or more of the blocks 615, 620 and 625 may be performed. For ease of discussion, it will be assumed that all are performed. However, it is to be understood that any one or more may be absent in various embodiments. Additionally, the order of the blocks depicted is exemplary only. Other embodiments may use a different ordering of the blocks.

After compressing the frame, the size of the compressed frame may be compared to a threshold size (block 615) as in FIG. 5. If the size does not exceed the threshold, then a determination may be made as to whether an idle condition has been detected (block 620). For example, as already discussed, some embodiments may detect the condition of block 615 (e.g., two consecutive unchanged frames) prior to detecting an idle frame condition (e.g., three consecutive unchanged frames). If the idle frame condition is detected, then additional factors may be considered to determine whether write back of a compressed frame is to be performed. In the embodiment shown, block 625 is used to represent consideration of these additional factors and is characterized as “Benefit Conditions Satisfied?” In general, these conditions may be configured to ascertain whether it would be beneficial from a power consumption standpoint to perform write back of the compressed frame. However, considerations other than power consumption could be used as desired. If the result of the processing of block 650 is that the conditions are satisfied, then write back of the compressed frame is initiated (block 630. Assuming the write back is successful, then processing will continue by reading and using the compressed frame data (block 640). If for some reason, the write back is not successful, then processing may continue with block 645 by fetching the original source buffer data.

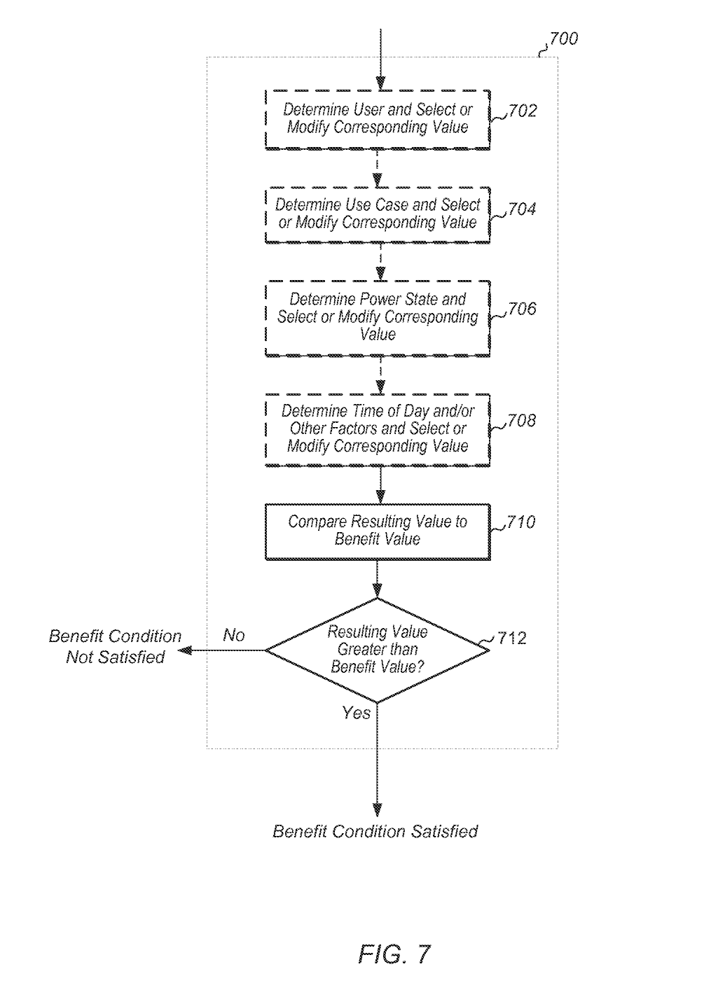

With regard to block 625 (Benefit Conditions Satisfied), FIG. 7 illustrates one possible embodiment 700 of the processing that may correspond to the block. In the example of FIG. 7, blocks 702, 704, 706, and 708 corresponds to various determinations that may or may not be included in a given embodiment. Various embodiments may include any combination of these blocks. Generally speaking, a benefit value may have been determined that represents a threshold value that must be met in order for the benefit condition to be satisfied. In this embodiment, the benefit condition being satisfied generally means that write back and use of compressed frame data meets some requirement in order to be performed. For example, it may be determined that an idle frame condition must persist for at least M frames (which may be represented by a corresponding benefit value) in order for compressed frame write back to be beneficial—either in terms of power consumption or otherwise. Various conditions or factors may affect an expected duration of an idle frame condition. By evaluating such conditions, estimating an expected idle frame condition duration, and comparing the expected duration to the benefit value, it may be determined whether the benefit condition is satisfied.

It is noted that the expected idle frame condition value may not genuinely represent an “expected duration” of an idle condition. As will be discussed in the following, various modifications may be made to such a value depending on various conditions. Such modifications may generally be configured to either increase or decrease the likelihood that a compressed frame write back will occur. As such, if for some reason a write back of the compressed frame is not desired, one could set the expected duration of the idle frame condition to zero—even if this is not genuinely expected. Other embodiments may use the expected duration as a more genuine expected duration of the idle frame condition. In the following discussion, both embodiments are possible and are contemplated.

As shown in FIG. 7, a determination is made as to an identify of the current user (or user account). It is noted that this determination may generally be made at a time of login to the device or account, and an identification of the user or account stored. This stored identification may then be accessed and used as part of block 702. Associated with the user or account, there may a value, scaling factor, or the like, that is used to set, select, or modify an expected idle frame condition duration. It may be the case that one user's usage patterns show longer average idle frame conditions than another user. On the basis of such information, the expected idle frame condition for this user may be longer than another.

Also shown in FIG. 7 is a determination as to a particular use case (scenario). This use case scenario may generally represent the type of activity in which a user is currently engaged. For example, determination of a use case may be based at least in part on a particular application (or “app”) currently being used. Such a determination could be based on a particular activity within a given application. Similar to the above described determination, there may a value, scaling factor, or the like, that is used to set, select, or modify an expected idle frame condition duration. If the embodiment includes similar determinations made prior to block 704 (e.g., block 702), then the scaling or modification may be applied to the value that results from the prior determination. In other words, the scaling or modifications may be cumulative.

Similar to the above, block 706 may determine a current power state for one or more units of the device. Depending on the power state of one or more units, the expected idle frame condition duration value may be modified. In block 708, a determination as to time of day is made (and potentially other factors not listed here) and modifications to the expected duration value may be made. As discussed above, different times of day may be associated with different user behavior. During certain hours of the day, shorter idle conditions may be detected. Such behaviors may be used when determining whether a write back of compressed frame data should be permitted.

Having determined and possibly modified the expected duration value, it may then be compared to a “benefit value.” If the expected duration value is at least equal to the benefit value, then the benefit condition may be deemed satisfied. Otherwise, the benefit condition may be deemed not satisfied.

While the above description describes the use of an expected duration and benefit value in terms of a number of frames, other embodiments may use other values that do not directly represent a number of frames. Other values could be used to represent power consumption, an amount of data, clock cycles, processing time, or otherwise. Alternatively, they may simply be abstract values that are used for purposes of comparison. Numerous such embodiments are possible and are contemplated.

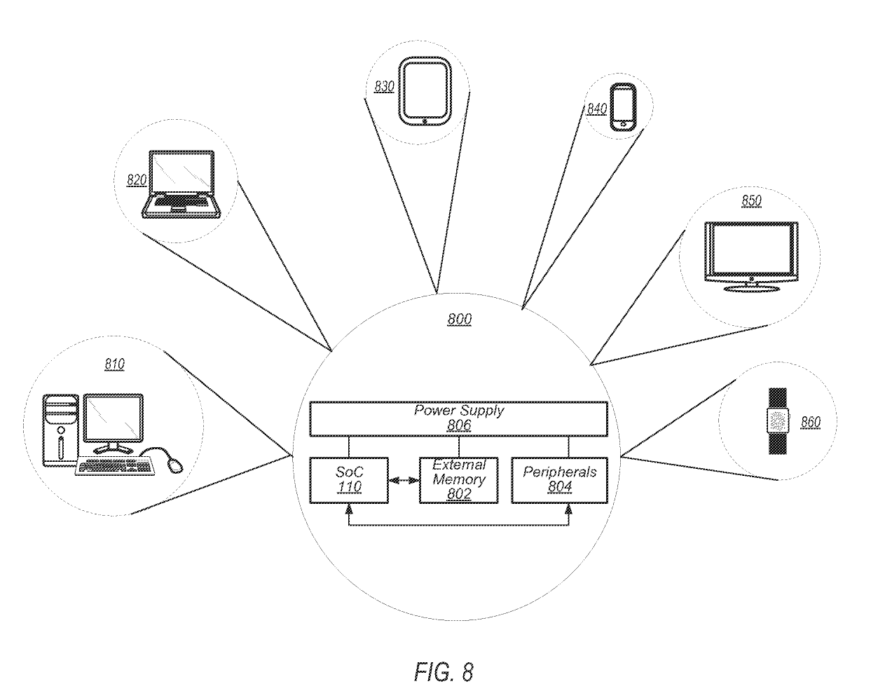

Turning next to FIG. 8, a block diagram of one embodiment of a system 800 is shown. As shown, system 800 may represent chip, circuitry, components, etc., of a desktop computer 810, laptop computer 820, tablet computer 830, cell phone 840, television 850 (or set top box configured to be coupled to a television), wrist watch or other wearable item 860, or otherwise. Other devices are possible and are contemplated. In the illustrated embodiment, the system 800 includes at least one instance of SoC 110 (of FIG. 1) coupled to an external memory 802.

SoC 110 is coupled to one or more peripherals 804 and the external memory 802. A power supply 806 is also provided which supplies the supply voltages to SoC 110 as well as one or more supply voltages to the memory 802 and/or the peripherals 804. In various embodiments, power supply 806 may represent a battery (e.g., a rechargeable battery in a smart phone, laptop or tablet computer). In some embodiments, more than one instance of SoC 110 may be included (and more than one external memory 802 may be included as well).

The memory 802 may be any type of memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with SoC 110 in a chip-on-chip configuration, a package-on-package configuration, or a multi-chip module configuration.

The peripherals 804 may include any desired circuitry, depending on the type of system 800. For example, in one embodiment, peripherals 804 may include devices for various types of wireless communication, such as wifi, Bluetooth, cellular, global positioning system, etc. The peripherals 804 may also include additional storage, including RAM storage, solid state storage, or disk storage. The peripherals 804 may include user interface devices such as a display screen, including touch display screens or multitouch display screens, keyboard or other input devices, microphones, speakers, etc.

In various embodiments, program instructions of a software application may be used to implement the methods and/or mechanisms previously described. The program instructions may describe the behavior of hardware in a high-level programming language, such as C. Alternatively, a hardware design language (HDL) may be used, such as Verilog. The program instructions may be stored on a non-transitory computer readable storage medium. Numerous types of storage media are available. The storage medium may be accessible by a computer during use to provide the program instructions and accompanying data to the computer for program execution. In some embodiments, a synthesis tool reads the program instructions in order to produce a netlist comprising a list of gates from a synthesis library.

It should be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A display control unit configured to:
initiate compression of a frame from source image data responsive to detecting a first condition;
if a second condition is met, permit a compressed frame to be written to memory; and
if the second condition is not met, prevent the compressed frame from being written to the memory.

2. The display control unit as recited in claim 1, wherein determining the second condition is met comprises determining a size of the compressed frame does not exceed a threshold size.

3. The display control unit as recited in claim 2, wherein determining the second condition is met further comprises determining an idle condition is met.

4. The display control unit as recited in claim 3, wherein determining the idle frame condition is met comprises detecting M consecutive unchanged frames, where M is an integer, and wherein determining the first condition is met comprises detecting N consecutive unchanged frames, where N is an integer that is greater than zero and less than M.

5. The display control unit as recited in claim 1, wherein responsive to determining the second condition is met, the display control unit is further configured to:
read the compressed frame from the memory;
decompress the compressed frame to regenerate the frame; and
drive the output frame to the display device.

6. The display control unit as recited in claim 1, wherein said initiating compression corresponds to a first frame, and wherein the compressed frame to be written to memory is a frame following the first frame.

7. The display control unit as recited in claim 1, wherein determining the second condition is met comprises:
determining a value based at least in part on one or more of a user identification, account identification, use case scenario, current power state, or time of day; and
comparing said value to a benefit value.

8. A method comprising:
initiating compression of a frame from source image data responsive to detecting a first condition;
if a second condition is met, permitting the compressed frame to be written to memory; and
if the second condition is not met, preventing the compressed frame from being written to the memory.

9. The method as recited in claim 8, wherein determining the second condition is met comprises determining a size of the compressed frame does not exceed a threshold size.

10. The method as recited in claim 9, wherein determining the second condition is met further comprises determining an idle condition is met.

11. The method as recited in claim 10, wherein determining the idle frame condition is met comprises detecting M consecutive unchanged frames, where M is an integer, and wherein determining the first condition is met comprises detecting N consecutive unchanged frames, where N is an integer that is greater than zero and less than M.

12. The method as recited in claim 8, wherein responsive to determining the second condition is met, the method further comprises:
reading the compressed frame from the memory;
decompressing the compressed frame to regenerate the output frame; and
driving the frame to the display device.

13. The method as recited in claim 8, wherein said initiating compression corresponds to a first frame, and wherein the compressed frame to be written to memory is a frame following the first frame.

14. The method as recited in claim 8, wherein determining the second condition is met comprises:
determining a value based at least in part on one or more of a user identification, account identification, use case scenario, current power state, or time of day; and
comparing said value to a benefit value.

15. A system comprising:
a display control unit; and
a memory;
wherein the display control unit is configured to:
initiate compression of a frame from source image data responsive to detecting a first condition;
if a second condition is met, permit the compressed frame to be written to memory; and
if the second condition is not met, prevent the compressed frame from being written to the memory.

16. The system as recited in claim 15, wherein to determine the second condition is met, the display control unit is configured to determine a size of the compressed frame does not exceed a threshold size.

17. The system as recited in claim 16, wherein to determine the second condition is met, the display control unit is configured to determine an idle condition is met.

18. The system as recited in claim 17, wherein determining the idle frame condition is met comprises detecting M consecutive unchanged frames, where M is an integer, and wherein determining the first condition is met comprises detecting N consecutive unchanged frames, where N is an integer that is greater than zero and less than M.

19. The system as recited in claim 15, wherein responsive to determining the second condition is met, the display control unit is further configured to:
read the compressed frame from the memory;
decompress the compressed frame to regenerate the output frame; and
drive the frame to the display device.

20. The system as recited in claim 15, wherein responsive to detecting the first condition, the display control unit is configured to compress the frame and write the compressed frame to the memory while simultaneously driving the frame for display on a display device.
